(19) United States
(12) Patent Application Publication
(10) Pub. No.: US 2023/0060331 A1
(43) Pub. Date: Mar. 2, 2023

(54) AUTOMATED AUTHENTICATION SYSTEM BASED ON TARGET-SPECIFIC IDENTIFIER

(71) Applicant: Synchrony Bank, Stamford, CT (US)

(72) Inventors: Theresa Kraus, Stamford, CT (US); Trevor Grandle, Stamford, CT (US); William Schroeder, Stamford, CT (US); Tara Carroll, Stamford, CT (US); Mary Angel Trammell, Stamford, CT (US); Edward Zhang, Stamford, CT (US); Amy Walter, Stamford, CT (US); Jay Neidermeyer, Stamford, CT (US); Pat Monnig, Stamford, CT (US); Carl Frazee, Stamford, CT (US)

(21) Appl. No.: 17/821,957

(22) Filed: Aug. 24, 2022

Related U.S. Application Data
(60) Provisional application No. 63/236,545, filed on Aug. 24, 2021.

(51) Int. Cl. G06Q 20/40; G06Q 30/00; G06Q 30/06; G06Q 20/38; G06Q 20/42

(52) U.S. Cl. CPC G06Q 20/4014; G06Q 30/0185; G06Q 30/0609; G06Q 20/382; G06Q 20/42

(57) ABSTRACT

The disclosure is directed to a continuously and automatically updated authentication mechanism for authentication, in real-time, the processing of transactions at point of sales devices based on corresponding target-specific identifiers. In one aspect, a processing server includes one or more memories having computer-readable instructions stored therein, and one or more processors. The one or more processors are configured to execute the computer-readable instructions to receive a request for processing a transaction; identify a merchant-specific identifier for a merchant associated with the transaction; determine, in real-time and using a machine trained model, whether the merchant-specific identifier is a valid merchant-specific identifier or not; and process the transaction based on whether the machine trained model indicates that the merchant-specific identifier is valid or not.

### CROSS-REFERENCE TO RELATED APPLICATIONS

The present patent application claims the priority benefit of U.S. Provisional Patent Application 63/236,545 filed Aug. 24, 2021, the disclosures of which are incorporated herein by reference.

### BACKGROUND

### Field of the Disclosure

The present disclosure relates to automated network architecture for payment processing system. More specifically, the disclosure is related to a continuously and automatically updated authentication mechanism for authentication, in real-time, the processing of transactions at point of sales devices based on corresponding target-specific identifiers.

### Description of the Related Art

Merchant Category Codes (MCCs) are numbers used to classify a business by the type of services or goods that business provides. MCCs can be four digit numbers. MCCs may be assigned either by merchant type (e.g., one for hotels, one for office supply stores, etc.) or by merchant name (e.g., 3000 for United Airlines) and may be assigned to a merchant by a credit card company when the merchant first starts accepting that card as a form of payment. The same merchant may have a different MCC with different sections or departments of the same business may have different MCCs. In addition, one merchant can be in multiple MCCs simultaneously.

MCC codes may be used for a variety of reasons, including but not limited to, determining the interchange fee paid by the merchant, credit card companies offering cash back rewards or reward points for spending in specific categories, card networks defining rules and restrictions for card transactions (for example, automated fuel dispensers may have specific rules for authentication and clearing messages), for tax purposes (e.g., to determine whether a payment is primarily for “services”, for “merchandise,” etc.).

### SUMMARY

As noted above, MCC codes are used by financial institutions and providers of credit card services for rewarding customers, defining rules and restrictions, etc. MCCs may be broadly defined to encompass various merchants that may not necessarily be associated with the same category of services and goods. Similarly, MCC codes may result in multiple merchants that should otherwise be in the same category (e.g., for points and reward assignments, etc.) to have different associated codes such that purchases at one merchant would reward the customer while purchases at another may not.

In addition to the inefficiencies that broad MCC categories may result in with regard to points and reward allocations, these broad MCCs also introduce security and undesired authentication of payments such that processing of transactions from a particular merchant that otherwise should not be authenticated, may be authenticated due to having a MCC code that the payment processing system of the card service provider permits, or may inadvertently decline a transaction that should otherwise be allowed. Businesses may also be associated with multiple MCCs at the same time that may result in inconsistent or incorrect denial or approval of transactions. Lastly, new businesses continuously emerge and/or existing businesses evolve to offer new or modified services and/or products. The process of assigning correct MCCs to new and ever-changing businesses is a manual process that entails inefficiencies at the backend processing system of the underlying financial institutions that provide card services.

To address the deficiencies in the existing legacy systems, hereinafter an automated and real-time processing systems and methods will be described, whereby transactions are identified and processed based on Merchant Identifiers (MIDs) that are specific to each merchant as opposed to currently utilized broader MCCs. As part of this processing, development of an automated backend component that is capable of continuously updating lists of authenticated/prohibited merchants based on MIDs to be used in making real-time decisions in authenticating or declining transactions will be described. In some examples, this backend component may be developed using machine learning techniques.

In one aspect, a processing server includes one or more memories having computer-readable instructions stored therein, and one or more processors. The one or more processors are configured to execute the computer-readable instructions to receive a request for processing a transaction; identify a merchant-specific identifier for a merchant associated with the transaction; determine, in real-time and using a machine trained model, whether the merchant-specific identifier is a valid merchant-specific identifier or not; and process the transaction based on whether the machine trained model indicates that the merchant-specific identifier is valid or not.

In another aspect, the one or more processors are configured to execute the computer-readable instructions to decline the transaction when the machine trained model indicates that merchant-specific identifier is not valid.

In another aspect, the one or more processors are configured to execute the computer-readable instructions to authorize the transaction when the machine trained model indicates that the merchant-specific identifier is valid.

In another aspect, the one or more processors are further configured to execute the computer-readable instructions to communicate a verification of a processed transaction to a point of sale device of the merchant.

In another aspect, the one or more processors are further configured to execute the computer-readable instructions to perform further authentication for the transaction if the merchant-specific identifier is valid.

In another aspect, the further authentication includes authenticating credit card information of a customer associated with the transaction.

In another aspect, the one or more processors are further configured to execute the computer-readable instructions to process the transaction if the further authentication of the transaction is successful.

In one aspect, one or more non-transitory computer-readable media include computer-readable instructions, which when executed by one or more processors, cause a processing server to: receive a request for processing a transaction; identify a merchant-specific identifier for a merchant associated with the transaction; determine, in real-time and using a machine trained model, whether the merchant-specific identifier is a valid merchant-specific identifier or not; and process the transaction based on whether the machine trained model indicates that the merchant-specific identifier is valid or not.

In one aspect, a method includes receiving, at a processing server, a request for processing a transaction; identifying, by the processing server, a merchant-specific identifier for a merchant associated with the transaction; determining, in real-time and using a machine trained model, whether the merchant-specific identifier is a valid merchant-specific identifier or not; and processing, by the processing server, the transaction based on whether the machine trained model indicates that the merchant-specific identifier is valid or not.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is an example system for monitoring and processing transactions and corresponding rewards, according to an aspect of the present disclosure;

FIG. 2 is an example method of merchant identifier-based transaction authentication, according to an aspect of the present disclosure;

FIG. 3 illustrates an example neural network architecture, according to one aspect of the present disclosure; and

FIGS. 4A and 4B illustrate systems, according to some aspects of the present disclosure.

### DETAILED DESCRIPTION

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Example embodiments of the present disclosure will be described more fully hereinafter with reference to the accompanying drawings in which like numerals represent like elements throughout the several figures, and in which example embodiments are shown. Example embodiments of the claims may, however, be embodied in many different forms and should not be construed as limited to the example embodiments set forth herein. The examples set forth herein are non-limiting examples and are merely examples among other possible examples.

As noted above, MCC codes are used by financial institutions and providers of credit card services for rewarding customers, defining rules and restrictions, etc. MCCs may be broadly defined to encompass various merchants that may not necessarily be associated with the same category of services and goods. Similarly, MCC codes may result in multiple merchants that should otherwise be in the same category (e.g., for points and reward assignments, etc.) to have different associated codes such that purchases at one merchant would reward the customer while purchases at another may not.

In addition to the inefficiencies that broad MCC categories may result in with regard to points and reward allocations, these broad MCCs also introduce security and undesired authentication of payments such that processing of transactions from a particular merchant that shouldn't otherwise be authenticated, may be authenticated due to having a MCC code that the payment processing system of the card service provider permits, or may inadvertently decline a transaction that should otherwise be allowed. Lastly, new businesses continuously emerge and/or existing businesses evolve to offer new or modified services and/or products. The process of assigning correct MCCs to new and ever changing businesses is a manual process that entails inefficiencies at the backend processing system of the underlying financial institutions that provide card services.

To address the deficiencies in the existing legacy systems, hereinafter an automated and real-time processing systems and methods will be described, whereby transactions are identified and processed based on Merchant Identifiers (MIDs) that are specific to each merchant as opposed to currently utilized broader MCCs. As part of this processing, development of an automated backend component that is capable of continuously updating lists of authenticated/prohibited merchants based on MIDs to be used in making real-time decisions in authenticating or declining transactions will be described. In some examples, this backend component may be developed using machine learning techniques.

The disclosure begins with a description of an example system in which the concepts presented herein may be implemented.

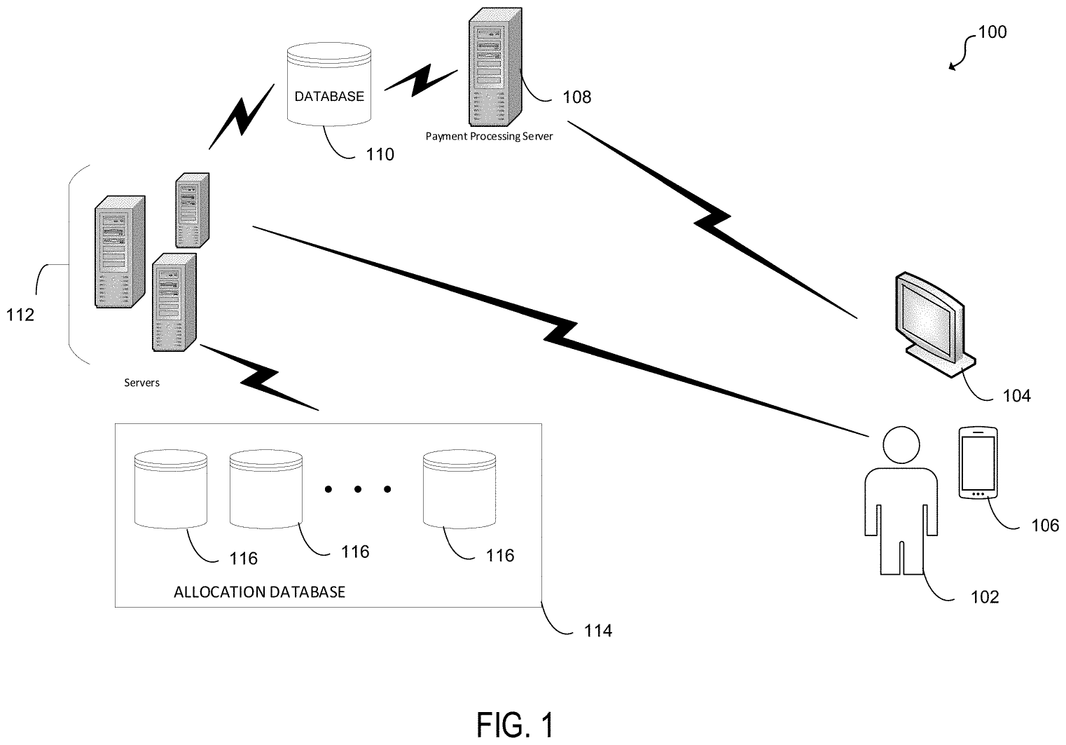

FIG. 1 is an example system for monitoring and processing transactions and corresponding rewards, according to an aspect of the present disclosure.

In setting 100, it is assumed that user 102 is at a Point of Sale (POS) device 104 conducting a transaction using a financial vehicle. The financial vehicle can be, but is not limited to, a credit card, a cardless method of payment using device 106, etc. Device 106 can be any known or to be developed mobile device, a laptop, a tablet, a smart device such as a smart watch, etc.

A transaction may be conducted with respect to a service or a product offered for sale by a merchant associated with POS device 104. Alternatively, a transaction may be an online commerce transaction where user 102, using device 106, conducts a transaction for a product or service offered by a merchant for sale online. In this context, POS device 104 may be a web payment portal or a website of a merchant. As part of the transaction, financial information of the financial vehicle (e.g., credit card number, associated security code, associated security code and/or zip code) may be provided to the merchant and used to charge the financial account of user 102 for the cost of products/services obtained.

A payment processing server 108 of a financial institution associated with the financial vehicle used for purchasing the product/service may then process the payment according to any known or to be developed method. In doing so, payment processing server 108 may communicate with one or more external payment processing servers and institutions of the merchant associated with POS device 104.

While FIG. 1 illustrates a single instance of a transaction, in reality many more transactions with users such as user 102 and merchants such as the merchant described with reference to POS device 104 may be conducted, which could be conducted simultaneously or not. Accordingly, there may be multiple payment processing servers such as payment processing server 108 utilized to handle processing all transactions.

As part of processing a given transaction, payment processing server 108 may identify a Merchant Category Code (MCC). A given merchant such as the merchant associated with POS device 104 may be registered with provider of a credit card service such as the provider (e.g., institution) associated with payment processing server 108. Upon registration, the provider may assign a MCC code or multiple MCC codes to the merchant depending on the type of goods or services the merchant provides. Therefore, when a request for processing a transaction at POS device 104 is received at payment processing server 108, payment processing server 108 can associated POS device 104 with an identifier of the merchant and hence the MCC code(s) of the merchant. Using the corresponding MCC code(s), payment processing server 108 can authenticate or decline the instant transaction that is requested to be processed and/or assign rewards/points to user 102, if rewards/points are applicable to the instant transaction being processed.

Examples of MCC codes include, but are not limited to, groceries, travel, entertainment, dining, gas, etc. Examples of merchant types can include any particular merchant such as a grocery store chain (e.g., SAFEWAY, WHOLE FOODS, etc.), a department store (e.g., MACY'S, JC PENNY, etc.), a brand store (e.g., BANNANA REPUBLIC, TIFFANY, etc.). Examples of product types or services include, but are not limited to, clothing, airlines, hotels, fitness, etc. More refined product types may include examples such as denims, jackets, shirts, jeans, lighting, furniture, books, electronics, etc.

Database 110 may store information on merchants and associated identifiers, newly configured and/or modified MCCs and MIDs, goods and services offered for sale by the merchants, processed transactions, etc. Setting 100 also includes one or more servers 112. At least one of servers 112 may be co-located in the same physical location or may be distributed remotely and communicatively coupled via a cloud based structure. As will be described below, one or more of servers 112 may monitor database 110 to determine (update) lists of authenticated (whitelist) and/or prohibited (blacklist) of merchants for which transactions should be authenticated or declined, respectively. This authentication or decline may be a MID-based (merchant-specific or target specific identifier) authentication/decline as opposed to MCC based authentication/decline of transactions.

As will be described below, prior to authenticating any given transaction, payment processing system 108 may communicate with one or more of servers 112 configured to maintain the whitelist/blacklist for MID-based authentication/decline of transactions (hereinafter may be referred to as the MID-based transaction authentication list), in order to make a determination as to whether to authenticate or decline a requested transaction (e.g., received from POS device 104). In another example, payment processing system 108 may perform the functionalities of the one or more of servers 112 in maintaining the MID-based transaction authentication list.

One or more additional ones of servers 112 may be configured to retrieve stored data strings (e.g., from database 110) associated with each recorded/processed transaction for purposes of automated reward allocation and optimization for each consumer such as user 102.

Setting 100 further illustrates details of an allocation database 114. Allocation database 114 may be utilized by merchant servers to store results of processing transactions for reward determination. Rewards servers 112 may analyze each transaction to identify MCC codes, merchant type, product type, transaction amount, etc., which may be referred to as transactions metadata used for defining categories for the transactions. In another example, rewards servers 112 may receive additional information (metadata) from merchants with which a user conducts transactions indicative of a user's behavioral transaction traits that may be used for separating transactions and assigning them to different buckets, as will be described below.

Categories may be defined based on one or more of the following. Furthermore, each category may have one or more point allocation schemes (e.g., 5-4-3-2-1, 3-2-1, etc.) associated therewith.

One example category is merchant category codes (MCC), each of which identifies a different product category (e.g., grocery, travel, dining, gas, etc.). Another example category is merchandise identifiers, each of which identifies a particular type of product (clothing, lighting, furniture, fitness equipment, etc.). In one example, product types may be defined with more granularity. For example, instead of assigning a different bucket to clothing, lighting, furniture, etc., a different category may be assigned to different types of clothing such as denims, jackets, jeans, etc., or different types of furniture such as beds, dining room furniture, etc.

Another example category is merchant identifiers, each of which identifies a different merchant (e.g., BANANA REPUBLIC v. WHOLE FOODS v. WALMART, etc., as described above).

Another example category is transactional behavioral identifiers, each of which corresponds to a different consumer transactional behavior, the metadata of which may be provided by merchants. Examples of transactional behavioral identifiers include referrals, in-store visits, online clicks, posts on social networks, etc.

Another example category is one or more bonusing identifiers, each of which specifies a structure for assigning bonus points to the corresponding transactions in the account. For example one bonusing structure may be used in conjunction with one or more categories described above. For example, a bonusing identifier may be used in conjunction with MCC codes such that when spending in a particular category exceeds a defined threshold, an additional multiplier may be applied to points assigned to transactions in the particular category.

Another example bonusing structure that may be used to define categories is looking at transactions across all categories (regardless of categories) and assigning different points to ranked transactions. For example, a single highest transaction may be assigned 3 points per dollar spent, second single highest transaction may be assigned 2 points per dollar spent, etc.

Transactions belonging to each category may then be stored in a corresponding bucket. Allocation database 114 may include several buckets 116 each corresponding to a different category. Over a predetermined period and for each user, transactions are categorized and stored in buckets 116, with rewards servers 112 then ranking buckets 116 at the end of each period for determining optimized allocation of points/rewards to the corresponding user.

In an alternative, setting 100 may be such that databases 110 and 114 are the same and/or that payment processing servers 108 and rewards servers 112 are the same as well.

In one example, financial institution associated with setting 100 may directly issue financial vehicles (e.g., credit cards) to consumers, in which case such financial institution defines categories (and corresponding point allocation schemes) for consumers to select from, based on which transactions are then separated into buckets for ranking and point assignment. In another example, such financial institution may issue a financial vehicle such as a credit card in partnership with a business partner (e.g., a particular retailer, a particular service provider, a particular product manufacturer, etc.). In such case, the business partner may specify one or more categories and one or more associated point allocation scheme, which are then made available to consumers. A consumer may then select one of the available categories and/or point allocation schemes to be applied to the account.

Various components of setting 100 may communicate with one another using any known or to be developed wired and/or wireless communication schemes, media and protocol. For example, as shown in FIG. 1, such communications may be wireless over a cellular connection, a Wi-Fi connection, etc.

With an example setting 100 described with reference to FIG. 1, the disclosure now describes an example method for MID-based transaction authentication.

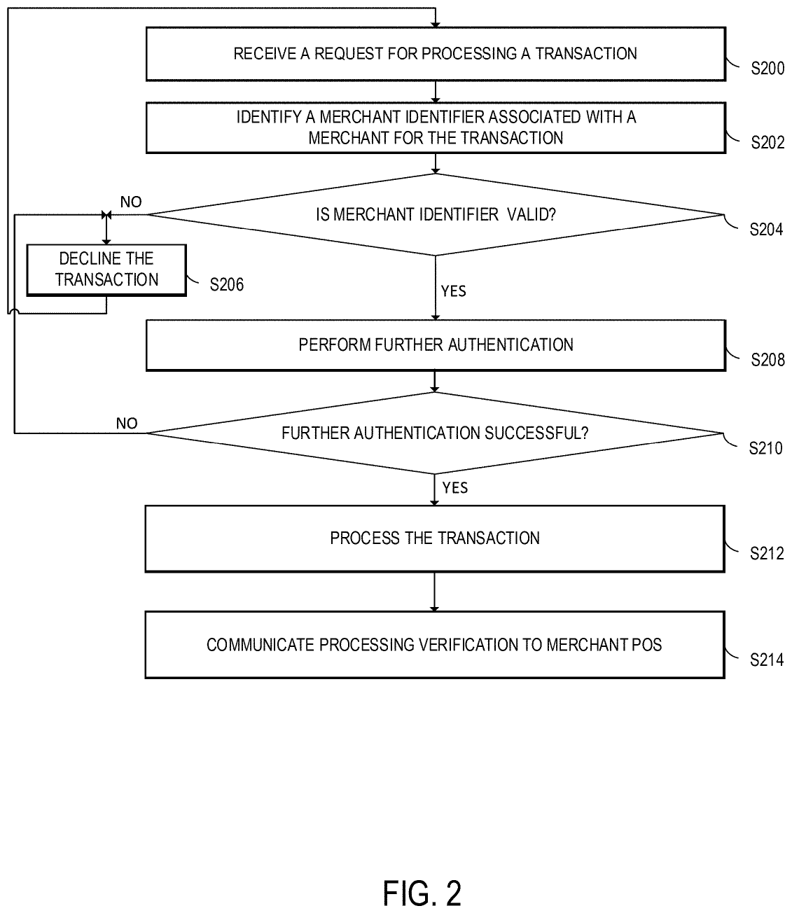

FIG. 2 is an example method of merchant identifier-based transaction authentication, according to an aspect of the present disclosure. FIG. 2 will be described from the perspective of payment processing server 108. However, it should be understood that payment processing server 108 may have one or more memories having stored thereon computer-readable instructions, which when executed by one or more associated processors, cause payment processing server 108 to perform functionalities described below with reference to FIG. 2.

As 5200, payment processing server 108 may receive a request for processing a transaction. Such request may be received from a POS device such as POS device 104 for a transaction between a merchant associated with POS device 104 and user 102. User 102 may use a credit card (issued by a financial institution associated with payment processing server 108) for the transaction or may use a digital credit card (e.g., stored on device 106 of user 102) issued by the financial institution associated with payment processing server 108. Such transaction can be for one or more goods offered for sale by merchant associated with POS device 104 or may be for a service (e.g., a medical service, auto service, etc.) offered by the merchant. In one example, the credit card (or the digital credit card) may be a private and specially designed credit card (e.g., for care services, auto services, etc.) issued by the financial institution thus allowing consumers such as user 102 to utilize the card at any merchant for such services and take advantage of associated benefits such as interest free installment payments, etc.

At S202, payment processing server 108, determines a merchant identifier (MID) of the merchant from which a request for processing the transaction is received at S200. A MID for the merchant may be determined by accessing a database of registered merchants (e.g., can be the same as database 110 or may be another database such as a MID database or table stored in a database not shown in FIG. 1) that the financial institution keeps when the merchant registers with the financial institution associated with payment processing server 108. In another example, payment processing server 108 may retrieve the MID for the merchant by accessing a third-party database (e.g., Discover merchant data) to determine the MID for the merchant.

In another example, MID information may be provided/continuously updated and stored in a MID database/list based on information provided by marketing, sales and credit team of the credit card service provide/financial institution associated with payment service provider 108.

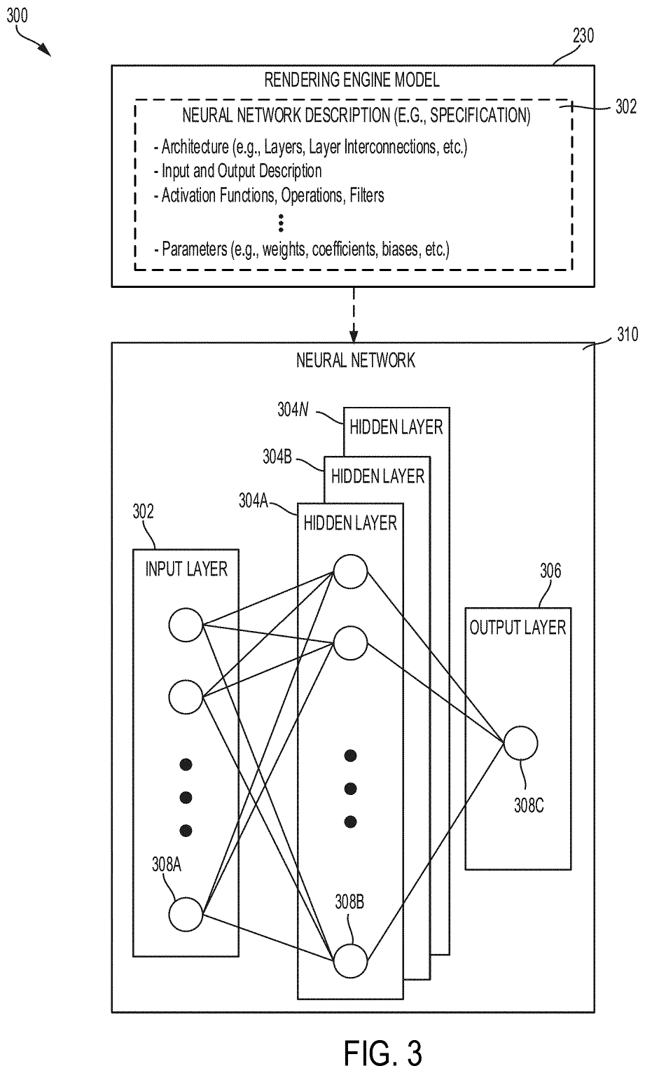

At S204, payment processing server 108 determines if a MID for the merchant is valid or not. In one example, payment processing server 108 compares the MID identified at S202 against a MID-based transaction authentication list (described above with reference to FIG. 1). Such MID-based transaction authentication list is a continuously updated list of MIDs for which transactions are to be authenticated or declined. In one example, the list is only a whitelist containing only MIDs that are authenticated for transaction processing. In another example, the list is a blacklist containing only prohibited MIDs for transaction processing. Creation and maintenance of MID-based transaction authentication list will be further described below with reference to FIG. 3.

If at S204, payment processing server 108 determines that the merchant's MID is not valid, then at S206, payment processing server 108 declines the transaction. Thereafter, the process ends until a next request for processing a transaction is received, at which point, payment processing server 108 starts the process of FIG. 2 again at S200.

However, if at S204, payment processing server 108 determines that the merchant's MID is valid, then at S208, payment processing server 108 performs further authentication for the transaction. Such further authentication can include, but is not limited to, verification of customer credit card information such as the credit card's Credit Verification Value (CVV), credit card's expiration, Address Verification Service AVS) verification, fraud or security alert verification, etc. In one example, fraud and security alert verification may entail determining whether the merchant is an authenticated merchant and/or whether the credit card used for the transaction is an authenticated credit card. Such security authentication of the merchant and/or credit card may be performed using a database or list that identifies fraudulent merchants, stolen or lost credit cards, etc. Such database may be internal to the backend system of the credit card provider/financial institution associated with payment processing server 108 or may be a third-party provided database accessible to payment processing server 108.

At S210, payment processing server 108 determines if further authentication has been successful or not. If not successful (e.g., any one of verifications such as CVV verification, credit card's expiation, AVS verification, fraud and security alert verification fails), the process reverts back to S206 and the transaction is declined. Thereafter, the process ends until a next request for processing a transaction is received, at which point, payment processing server 108 starts the process of FIG. 2 again at S200.

However, if at S210, payment processing server 108 determines that the further authentication has been successful (e.g., if all of the example verifications such as CVV verification, credit card's expiation, AVS verification, fraud and security alert verification are successful), then at S212, payment processing server 108 processes the transaction requested at S200. Thereafter, at S214, payment processing server 108 communicates a verification of the processing to POS device 104.

With an example of MID-based authentication of transactions described with reference to FIG. 2, the description now turns to development and maintenance of MID-based transaction authentication list. As mentioned above, the MID-based transaction authentication list may be developed and maintained using machine learning techniques (described with reference to FIG. 3) so as to provide a dynamic list that reflects in real-time an optimized categorization of authenticated/prohibited MIDs.

In existing industry standards for using MCCs for authenticating transactions and rewarding points, etc. a broad category may include various types of different merchants, which may not necessarily align with business goals/objectives of a financial institution that issues credit cards for specific purposes to consumers. For example, a financial institution may issue a credit card that provides consumers with awards and benefits in the sport goods sector or homes sector. MCCs may be defined such that sales of guns fall under sporting goods as well as other conventional sporting goods. For various reasons, the financial institution may not desire to include/provide benefits to consumers for purchasing guns. In this instance, defining a separate MCC for gun sales may not be possible or may be cost prohibitive as many merchants involved with sales of guns also offer other sporting goods for sale. This problem can be compounded when one or more merchants are each assigned more than one MCC code.

In another instance, a financial institution may offer a credit card service to consumers for use with their health/medical related needs. Such card may be advertised as providing consumers with points, financing options, etc. However, there may be merchants (e.g., care providers) running unauthorized POS devices for processing transactions. Therefore, such merchants may need to be blocked from processing transactions, which is not possibly by reliance on the one or more MCC codes assigned to such merchants.

In another instance, as new business types, products and/or services emerged, the financial institution may wish to define a new category of services with corresponding credit cards and benefits and/or may wish to expand an existing credit card service (e.g., auto services, home services, medical/health services) to include such new and emerging products or services. For example, the financial institution may wish to expand an existing credit card service for Auto care sector to include electric vehicle charging and related services.

In another instance, there may be “bad acting” merchants within a given MCC that may need to be identified in order to block transactions to be processed therefor. Relying on MCCs alone may be insufficient.

In another instance, there may be one or more merchants that are wrongly categorized into a given MCC or multiple MCCs and thus transactions conducted at their respective POS devices may not be correctly detected for authentication, rewards, etc.

In sum, there may be continuous and “on-the-fly” need to update a MID-based transaction authentication list based on evolving business needs and policies, security and fraud policies, etc., for which MCCs cannot be adjusted or doing is cost prohibitive and resource intensive, or even if adjusted, would be insufficient in achieving the desired business and/or security objective.

To address this, the present disclosure provides a mechanism for continuously updating a MID-based transaction authentication list. This updating may be based on manual inputs such as identification of authenticated and blocked MIDs, etc. In another instance, such updating can be achieved using a machine learning model trained (a neural network model) to receive as input one or more parameters and provide as output whitelisted MID(s) or blacklisted MID(s).

For instance, one or more servers 112 may train a model to receive various business objectives, updated merchant information, newly on-boarded merchant information, and merchant identifiers (MIDs) and provide as output a MID-based transaction authentication list that can be used in the process of FIG. 2 to identify a MID as valid or not, at S204. In addition to receiving the above-mentioned inputs, the model can continuously monitor various merchant transactions and adjust designation of a MID as valid or not in the MID-based transaction authentication list. For example and in the context of sporting goods and gun sales examples above, a MID may be blocked when the model determines that a threshold number of transactions are conducted for gun purchases but once the same MID stops gun related transactions for a period of time that is greater than a threshold or when gun sales fall below a predetermined and configurable threshold, then the

MID may automatically be designated as a valid MID in the MID-based transaction authentication list.

Once the machine learning model is trained, the model (e.g., implemented at payment processing server 108 or one or more servers 112 of FIG. 1) can receive, as input a MID detected upon receiving a request for processing a transaction (e.g., at S200 of FIG. 2), and provide as output a designation of the MID as a valid MID or an invalid MID. In one instance, the MID may be analyzed by the machine trained model against various business and security objectives to determine if the MID should be designated as valid or not.

An example process of training a neural network (machine learning model) for providing a MID-based transaction authentication list, will be described next. FIG. 3 illustrates an example neural network architecture, according to one aspect of the present disclosure.

FIG. 3 illustrates an example neural network architecture, according to one aspect of the present disclosure. Architecture 300 includes a neural network 310 defined by an example neural network description 301 in rendering engine model (neural controller) 330. The neural network 310 can represent a neural network implementation of a rendering engine for rendering media data. Neural network description 301 can include a full specification of neural network 310, including neural network architecture 300. For example, the neural network description 301 can include a description or specification of architecture 300 of neural network 310 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

Neural network 310 reflects architecture 300 defined in neural network description 301. In this example, neural network 310 includes an input layer 302, which includes input data, such as institutional policies on types or categories of merchants to be designated as valid, merchant activities that may affect a merchant designation as valid or not in the MID-based transaction authentication list, network security policies and or merchant activities that may be indicative of unauthorized or suspicious MIDs to be designated as invalid, etc.

Neural network 310 includes hidden layers 304A through 304N (collectively “304” hereinafter). Hidden layers 304 can include n number of hidden layers, where n is an integer greater than or equal to one. The number of hidden layers can include as many layers as needed for a desired processing outcome and/or rendering intent. Neural network 310 further includes an output layer 306 that provides an output (e.g., a designation of a MID as a valid MID or an invalid MID) resulting from the processing performed by hidden layers 304.

Neural network 310 in this example is a multi-layer neural network of interconnected nodes. Each node can represent a piece of information. Information associated with the nodes is shared among the different layers and each layer retains information as information is processed. In some cases, neural network 310 can include a feed-forward neural network, in which case there are no feedback connections where outputs of the neural network are fed back into itself. In other cases, neural network 310 can include a recurrent neural network, which can have loops that allow information to be carried across nodes while reading in input.

Information can be exchanged between nodes through node-to-node interconnections between the various layers. Nodes of input layer 302 can activate a set of nodes in first hidden layer 304A. For example, as shown, each of the input nodes of input layer 302 is connected to each of the nodes of first hidden layer 304A. Nodes of hidden layer 304A can transform the information of each input node by applying activation functions to the information. The information derived from the transformation can then be passed to and can activate the nodes of the next hidden layer (e.g., 304B), which can perform their own designated functions. Example functions include convolutional, up-sampling, data transformation, pooling, and/or any other suitable functions. The output of the hidden layer (e.g., 304B) can then activate nodes of the next hidden layer (e.g., 304N), and so on. The output of the last hidden layer can activate one or more nodes of the output layer 306, at which point an output is provided. In some cases, while nodes (e.g., nodes 308A, 308B, 308C) in neural network 310 are shown as having multiple output lines, a node has a single output and all lines shown as being output from a node represent the same output value.

In some cases, each node or interconnection between nodes can have a weight that is a set of parameters derived from training neural network 310. For example, an interconnection between nodes can represent a piece of information learned about the interconnected nodes. The interconnection can have a numeric weight that can be tuned (e.g., based on a training dataset), allowing neural network 310 to be adaptive to inputs and able to learn as more data is processed.

Neural network 310 can be pre-trained to process the features from the data in input layer 302 using the different hidden layers 304 in order to provide the output through output layer 306. In an example in which neural network 310 is used to determine whether an input merchant identifier (MID) is valid or not, neural network 310 can be trained using training data that includes institutional policies on types or categories of merchants to be designated as valid, merchant activities that may affect a merchant designation as valid or not in the MID-based transaction authentication list, network security policies and or merchant activities that may be indicative of unauthorized or suspicious MIDs to be designated as invalid, etc.

In some cases, neural network 310 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 310, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 310 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 310 can perform a backward pass by determining which inputs (weights) most contributed to the loss of the neural network 310, and can adjust the weights so that the loss decreases and is eventually minimized.

A derivative of the loss with respect to the weights can be computed to determine the weights that contributed most to the loss of neural network 310. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 310 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, neural network 310 can represent any other neural or deep learning network, such as an autoencoder, a deep belief nets (DBNs), a recurrent neural networks (RNNs), etc.

With example systems and methods for automated authentication systems based on target specific identifiers (e.g., MIDs) described above, the disclosure now turns to example system components and architectures that can be used to implement example systems and components such as rewards servers 112, user device 106, POS device 104, payment processing server 108, etc.

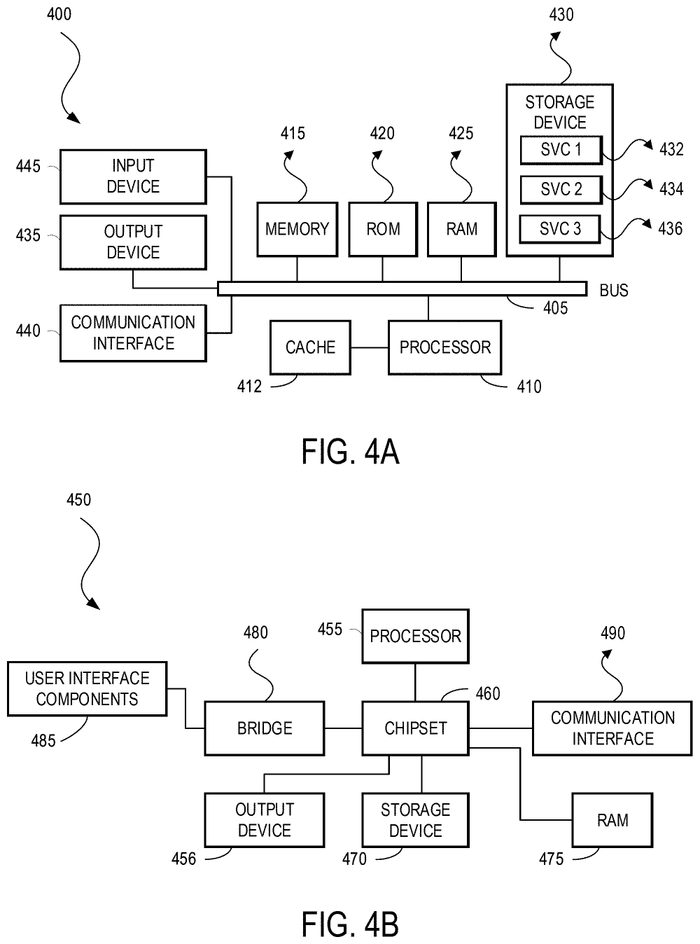

FIGS. 4A and 4B illustrate systems, according to some aspects of the present disclosure. Illustrated example systems can be used to implement any one or more of payment processing system 108, one or more servers 112, POS device 104 and/or mobile device 102 of user 102, as described above with reference to FIG. 1. Additionally, example systems of FIGS. 4A and 4B may be utilized as any other component for proper implementation of example embodiments described above. The more appropriate system will be apparent to those of ordinary skill in the art when practicing the various embodiments. Persons of ordinary skill in the art will also readily appreciate that other systems are possible.

FIG. 4A illustrates an example of a bus computing system 400 wherein the components of the system are in electrical communication with each other using a bus 405. The computing system 400 can include a processing unit (CPU or processor) 410 and a system bus 405 that may couple various system components including the system memory 415, such as read only memory (ROM) 420 and random access memory (RAM) 425, to the processor 410. The computing system 400 can include a cache 412 of high-speed memory connected directly with, in close proximity to, or integrated as part of the processor 410. The computing system 400 can copy data from the memory 415, ROM 420, RAM 425, and/or storage device 430 to the cache 412 for quick access by the processor 410. In this way, the cache 412 can provide a performance boost that avoids processor delays while waiting for data. These and other modules can control the processor 410 to perform various actions. Other system memory 415 may be available for use as well. The memory 415 can include multiple different types of memory with different performance characteristics. The processor 410 can include any general purpose processor and a hardware module or software module, such as services (SVC) 1 432, SVC 2 434, and SVC 3 436 stored in the storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing system 400, an input device 445 can represent any number of input mechanisms, such as a microphone for speech, a touch-protected screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing system 400. The communications interface 440 can govern and manage the user input and system output. There may be no restriction on operating on any particular hardware arrangement and therefore the basic features here may easily be substituted for improved hardware or firmware arrangements as they are developed.

The storage device 430 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof

As discussed above, the storage device 430 can include the software SVCs 432, 434, 436 for controlling the processor 410. Other hardware or software modules are contemplated. The storage device 430 can be connected to the system bus 405. In some embodiments, a hardware module that performs a particular function can include a software component stored in a computer-readable medium in connection with the necessary hardware components, such as the processor 410, bus 405, output device 435, and so forth, to carry out the function.

FIG. 4B illustrates an example architecture for a chipset computing system 450 that can be used in accordance with an embodiment. The computing system 450 can include a processor 455, representative of any number of physically and/or logically distinct resources capable of executing software, firmware, and hardware configured to perform identified computations. The processor 455 can communicate with a chipset 460 that can control input to and output from the processor 455. In this example, the chipset 460 can output information to an output device 465, such as a display, and can read and write information to storage device 470, which can include magnetic media, solid state media, and other suitable storage media. The chipset 460 can also read data from and write data to RAM 475. A bridge 480 for interfacing with a variety of user interface components 485 can be provided for interfacing with the chipset 460. The user interface components 485 can include a keyboard, a microphone, touch detection and processing circuitry, a pointing device, such as a mouse, and so on. Inputs to the computing system 450 can come from any of a variety of sources, machine generated and/or human generated.

The chipset 460 can also interface with one or more communication interfaces 490 that can have different physical interfaces. The communication interfaces 490 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 455 analyzing data stored in the storage device 470 or the RAM 475. Further, the computing system 450 can receive inputs from a user via the user interface components 485 and execute appropriate functions, such as browsing functions by interpreting these inputs using the processor 455.

It will be appreciated that computing systems 400 and 450 can have more than one processor 410 and 455, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some example embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the various embodiments may be presented as including individual functional blocks including functional blocks comprising devices, device components, steps or routines in a method embodied in software, or combinations of hardware and software.

Claim language reciting “at least one of” refers to at least one of a set and indicates that one member of the set or multiple members of the set satisfy the claim. For example, claim language reciting “at least one of A and B” means A, B, or A and B.

Like reference numbers and designations in the various drawings indicate like elements.

The disclosed secure and automated system for processing of time sensitive data can be performed using a computing server. An example computing server can include a processor (e.g., a central processing unit), memory, non-volatile memory, and an interface device. The memory may store data and/or and one or more code sets, software, scripts, etc. The components of the computer server can be coupled together via a bus or through some other known or convenient device. The processor may be configured to carry out all or part of methods described herein for example by executing code for example stored in memory. One or more of a user device or computer, a provider server or server, or a suspended database update server may include the components of the computing server or variations on such a server.

This disclosure contemplates the computer server taking any suitable physical form. As example and not by way of limitation, the computer server may be an embedded computer server, a server-on-chip (SOC), a single-board computer server (SBC) (such as, for example, a computer-on-module (COM) or server-on-module (SOM)), a desktop computer server, a laptop or notebook computer server, an interactive kiosk, a mainframe, a mesh of computer servers, a mobile telephone, a personal digital assistant (PDA), a server, or a combination of two or more of these. Where appropriate, the computer server may include one or more computer servers; be unitary or distributed; span multiple locations; span multiple machines; and/or reside in a cloud, which may include one or more cloud components in one or more networks. Where appropriate, one or more computer servers may perform without substantial spatial or temporal limitation one or more steps of one or more methods described or illustrated herein. As an example and not by way of limitation, one or more computer servers may perform in real time or in batch mode one or more steps of one or more methods described or illustrated herein. One or more computer servers may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because servers can be created with all applicable data available in memory. A typical computer server will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couples the processor to the network interface device. The interface can include one or more of a modem or network interface. It will be appreciated that a modem or network interface can be considered to be part of the computer server. The interface can include an analog modem, Integrated Services Digital network (ISDNO modem, cable modem, token ring interface, satellite transmission interface (e.g., “direct PC”), or other interfaces for coupling a computer server to other computer servers. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer server can be controlled by operating server software that includes a file management server, such as a disk operating server. One example of operating server software with associated file management server software is the family of operating servers known as Windows® from Microsoft Corporation of Redmond, Wash., and their associated file management servers. Another example of operating server software with its associated file management server software is the Linux™ operating server and its associated file management server. The file management server can be stored in the non-volatile memory and/or drive unit and can cause the processor to execute the various acts required by the operating server to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer server, or similar electronic computing device, that manipulates and transforms data represented as physical (electronic) quantities within registers and memories of the computer server into other data similarly represented as physical quantities within the computer server memories or registers or other such information storage, transmission or display devices.

The algorithms and displays presented herein are not inherently related to any particular computer or other apparatus. Various general purpose servers may be used with programs in accordance with the teachings herein, or it may prove convenient to construct more specialized apparatus to perform the methods of some examples. The required structure for a variety of these servers will appear from the description below. In addition, the techniques are not described with reference to any particular programming language, and various examples may thus be implemented using a variety of programming languages.

In various implementations, the server operates as a standalone device or may be connected (e.g., networked) to other servers. In a networked deployment, the server may operate in the capacity of a server or a client server in a client-server network environment, or as a peer server in a peer-to-peer (or distributed) network environment.

The server may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any server capable of executing a set of instructions (sequential or otherwise) that specify actions to be taken by that server.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the server and that cause the server to perform any one or more of the methodologies or modules of disclosed herein.

In general, the routines executed to implement the implementations of the disclosure, may be implemented as part of an operating server or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer servers, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a server, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ servers having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other servers, not necessarily the server described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the servers, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the server may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer server bus. Furthermore, any computing servers referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of servers and components for a contextual connection server. It will be understood by one of ordinary skill in the art, however, that the implementations described above may be practiced without these specific details. For example, circuits, servers, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing servers that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback server, a printer, and/or other types of output devices. A data storage device, such as a hard drive or flash memory, can enable the computing device to temporarily or permanently store data. A network interface, such as a wireless or wired interface, can enable the computing device to communicate with a network.

Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall server. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update server.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

Thus, particular embodiments of the invention have been described. Other embodiments are within the scope of the following claims. For example, the actions recited in the claims can be performed in a different order and still achieve desirable results.

What is claimed is:

1. A processing server comprising:
one or more memories having computer-readable instructions stored therein; and
one or more processors configured to execute the computer-readable instructions to:
receive a request for processing a transaction;
identify a merchant-specific identifier for a merchant associated with the transaction;
determine, in real-time and using a machine trained model, whether the merchant-specific identifier is a valid merchant-specific identifier or not; and
process the transaction based on whether the machine trained model indicates that the merchant-specific identifier is valid or not.

2. The processing server of claim 1, wherein the one or more processors are configured to execute the computer-readable instructions to decline the transaction when the machine trained model indicates that merchant-specific identifier is not valid.

3. The processing server of claim 1, wherein the one or more processors are configured to execute the computer-readable instructions to authorize the transaction when the machine trained model indicates that the merchant-specific identifier is valid.

4. The processing server of claim 1, wherein the one or more processors are further configured to execute the computer-readable instructions to communicate a verification of a processed transaction to a point of sale device of the merchant.

5. The processing server of claim 1, wherein the one or more processors are further configured to execute the computer-readable instructions to perform further authentication for the transaction if the merchant-specific identifier is valid.

6. The processing server of claim 5, wherein the further authentication includes authenticating credit card information of a customer associated with the transaction.

7. The processing server of claim 5, wherein the one or more processors are further configured to execute the computer-readable instructions to process the transaction if the further authentication of the transaction is successful.

8. One or more non-transitory computer-readable media comprising computer-readable instructions, which when executed by one or more processors, cause a processing server to:
receive a request for processing a transaction;
identify a merchant-specific identifier for a merchant associated with the transaction;
determine, in real-time and using a machine trained model, whether the merchant-specific identifier is a valid merchant-specific identifier or not; and
process the transaction based on whether the machine trained model indicates that the merchant-specific identifier is valid or not.

9. The one or more non-transitory computer-readable media of claim 8, wherein the execution of the computer-readable instructions further cause the payment processing server to decline the transaction when the machine trained model indicates that merchant-specific identifier is not valid.

10. The one or more non-transitory computer-readable media of claim 8, wherein the execution of the computer-readable instructions further cause the payment processing server to authorize the transaction when the machine trained model indicates that the merchant-specific identifier is valid.

11. The one or more non-transitory computer-readable media of claim 8, wherein the execution of the computer-readable instructions further cause the payment processing server to communicate a verification of a processed transaction to a point of sale device of the merchant.

12. The one or more non-transitory computer-readable media of claim 8, wherein the execution of the computer-readable instructions further cause the payment processing server to perform further authentication for the transaction if the merchant-specific identifier is valid.

13. The one or more non-transitory computer-readable media of claim 12, wherein the further authentication includes authenticating credit card information of a customer associated with the transaction.

14. The one or more non-transitory computer-readable media of claim 12, wherein the execution of the computer-readable instructions further cause the payment processing server to process the transaction if the further authentication of the transaction is successful.

15. A method comprising:
receiving, at a processing server, a request for processing a transaction;
identifying, by the processing server, a merchant-specific identifier for a merchant associated with the transaction;
determining, in real-time and using a machine trained model, whether the merchant-specific identifier is a valid merchant-specific identifier or not; and
processing, by the processing server, the transaction based on whether the machine trained model indicates that the merchant-specific identifier is valid or not.

16. The method of claim 15, wherein processing the transaction includes declining the transaction when the machine trained model indicates that merchant-specific identifier is not valid.

17. The method of claim 15, wherein processing the transaction includes authorizing the transaction when the machine trained model indicates that the merchant-specific identifier is valid.

18. The method of claim 15, further comprising:
communicating a verification of a processed transaction to a point of sale device of the merchant.

19. The method of claim 15, further comprising:
performing a further authentication for the transaction if the merchant-specific identifier is valid, wherein the further authentication includes authenticating credit card information of a customer associated with the transaction.

20. The method of claim 19, further comprising:
processing the transaction if the further authentication of the transaction is successful.
